(19) United States
(12) Patent Application Publication
(10) Pub. No.: US 2018/0210475 A1
(43) Pub. Date: Jul. 26, 2018

(54) ENERGY SAVING CONTROL STRUCTURE FOR WATER-COOLED AIR CONDITIONING

(71) Applicant: Chin-Tsun Yang, New Taipei City (TW)

(72) Inventor: Chin-Tsun Yang, New Taipei City (TW)

(21) Appl. No.: 15/614,639

(22) Filed: Jun. 6, 2017

(30) Foreign Application Priority Data
Jan. 26, 2017 (TW) 106201527

(51) Int. Cl. G05D 23/24; G05D 23/19

(52) U.S. Cl. CPC G05D 23/24; F24F 5/0035; G05D 23/19

(57) ABSTRACT

An energy saving control structure for water-cooled air conditioning includes: a power module; a first electric circuit, configured on one side of the power module and in selective electric connection therewith, the first electric circuit in electric connection with at least one air circulation device; and a second electric circuit, configured on another side of the power module and in selective electric connection therewith, the second electric circuit in electric connection with at least one cooling device and a compressor configured on one side of the cooling device, and the cooling device including a fan motor of a cooling water tower and at least one second motor configured on one side of the fan motor of the cooling water tower.

### (a) TECHNICAL FIELD OF THE INVENTION

The present invention relates to an energy saving control structure for water-cooled air conditioning, and more particularly to an energy saving control structure for water-cooled air conditioning, capable of cutting off a unnecessary circuit to keep air circulation after temperature is lowered, thereby achieving energy-saving.

### (b) DESCRIPTION OF THE PRIOR ART

General available air conditioning facilities, according to cooling ways, are divided into air-cooled air conditioning and water-cooled air conditioning, where the water-cooled air conditioning is air conditioning in which a compressor absorbs indoor heat with refrigerant, and the absorbed heat energy is carried to an outdoor cooling water tower for heat dissipation through water, while the air-cooled air conditioning is air conditioning in which the refrigerant processed by a compressor is performed heat exchange directly with air through metal piping. These two air conditioning types have their own advantages and disadvantages; among these, the water-cooled air conditioning is mostly used in large shopping malls or public buildings such as stations, event centers and so on. In addition, to match global warming slow-down, consideration must be given to both air conditioning enjoyment and energy saving; a power switch for the detection of temperature is configured on conventional air supply equipment; a compressor is turned off automatically to stop the operation of the compressor when indoor temperature is lowered to a user's set temperature so as to achieve the energy saving effect.

However, the power switch for the detection of temperature has the following problems and disadvantages in use: when indoor temperature is decreased to the user's set temperature, the compressor can be turned off automatically to stop the operation thereof, and refrigerant also stops absorbing heat when the compressor is stopped so that it is unnecessary to cool the refrigerant, but outdoor cooling devices such as the motors of a fan and cooling piping are still running continuously, causing energy waste and reducing greatly energy saving efficiency.

### SUMMARY OF THE INVENTION

The main object of the present invention is to provide an energy saving control structure for water-cooled air conditioning, allowing a first electric circuit of an indoor air circulation device and a second electric circuit of a cooling device and compressor to be separate, independent circuits through the designs of the first and second electric circuits.

Another object of the present invention is to provide an energy saving control structure for water-cooled air conditioning, capable of closing the power of the second electric circuit when indoor temperature is decreased to user's set temperature, allowing the cooling device and compressor to be cut off, thereby reducing unnecessary energy consumption, and only providing indoor air circulation so as to save energy.

To achieve the objects mentioned above, the present invention proposes an energy saving control structure for water-cooled air conditioning, including: a power module; a first electric circuit, configured on one side of the power module and in selective electric connection therewith, the first electric circuit in electric connection with at least one air circulation device; and a second electric circuit, configured on another side of the power module and in selective electric connection therewith, the second electric circuit in electric connection with at least one cooling device and a compressor configured on one side of the cooling device, and the cooling device including a fan motor of a cooling water tower and at least one second motor configured on one side of the fan motor of the cooling water tower; thus, indoor heat can be absorbed with refrigerant through the air circulation device and compressor, and the refrigerant temperature is allowed to be decreased through the water in cooling device, where the fan motor of the cooling water tower and second motor are operated separately, individually, the fan motor of the cooling water tower can drive the fan of the cooling tower to decrease the water temperature, and the second motor allows the cooling water to be in heat exchange with the refrigerant continuously. When the indoor temperature is decreased to a user's set temperature, the power module cuts off the second electric circuit in electric connection with the outdoor cooling device and compressor, allowing the fan motor, second motor and compressor to be cut off so as to reduce unnecessary energy consumption, and allow only the first electric circuit to be electrified, thereby allowing the air circulation device to continue air circulation in the room, and achieving electricity saving.

With the above technologies, the defect of conventional power switch for detecting temperature that only the power of the compressor is cut off when the indoor temperature is decreased to a user's set temperature and the outdoor cooling device such as the fan motor of the cooling water tower and the motor of cooling piping is still in operation, causing excess energy consumption can be solved.

### BRIEF DESCRIPTION OF THE DRAWINGS

FIG. 1 is a perspective view of a preferred embodiment according to the present invention;

FIG. 2 is a structural block diagram of the embodiment according to the present invention;

FIG. 3 is a structure of the embodiment of the present invention while a second electric circuit is conducted electrically;

FIG. 4 is a structure of the embodiment of the present invention while a second electric circuit is cut off; and

FIG. 5 is a perspective view of the embodiment according to the present invention in implementation.

### DETAILED DESCRIPTION OF THE PREFERRED EMBODIMENTS

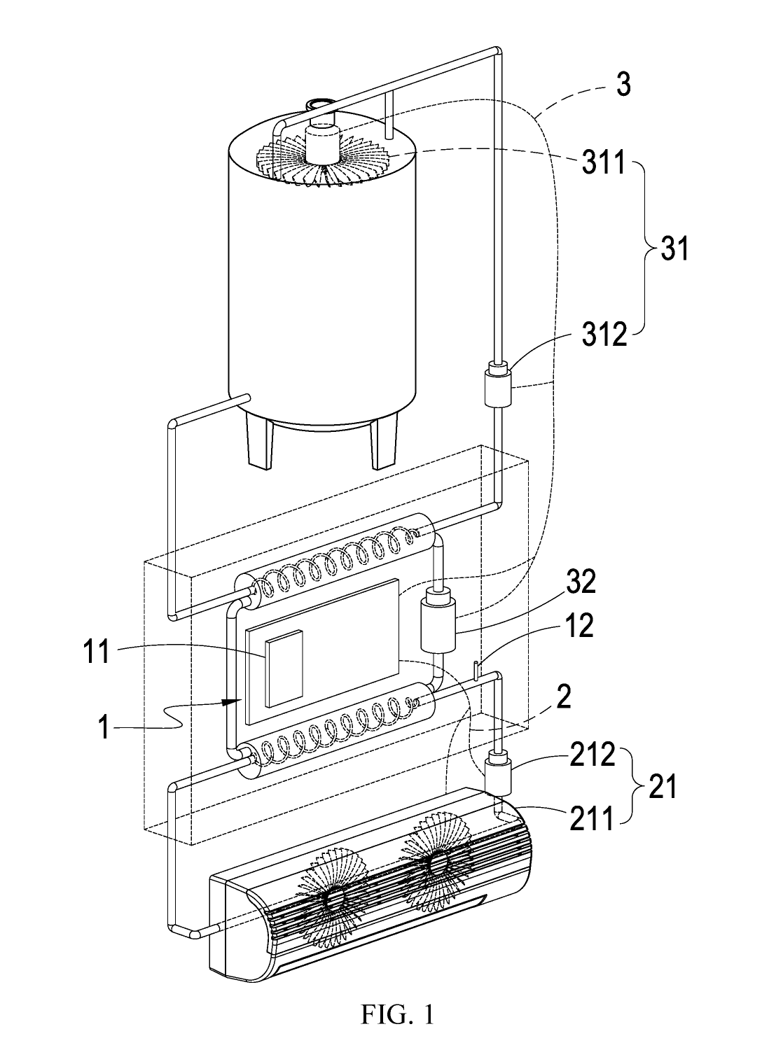

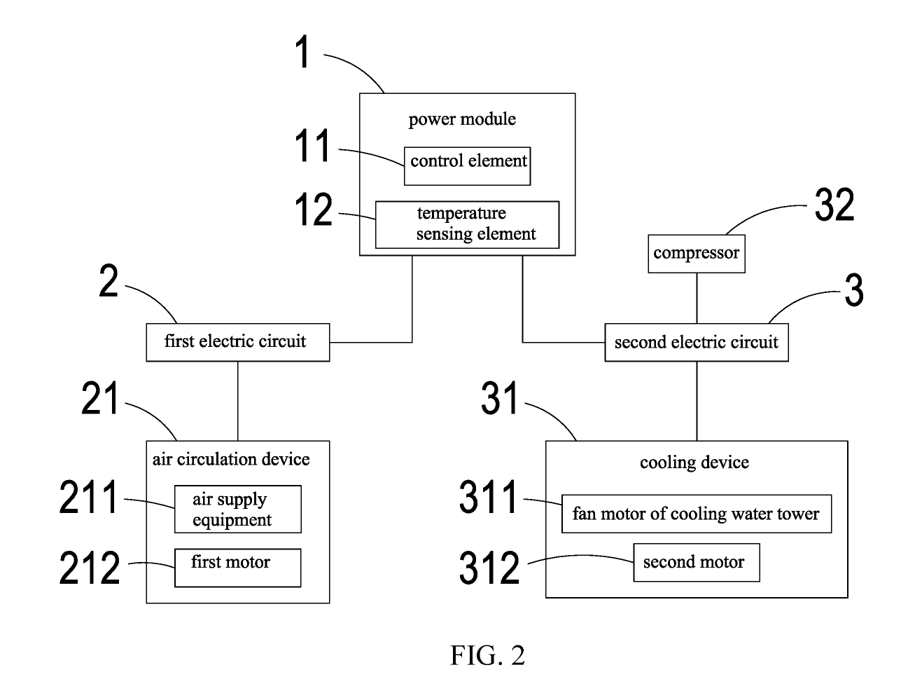

Referring to FIGS. 1 and 2, which respectively are a perspective view and structural block diagram of a preferred embodiment according to the present invention, it can be clearly seen that an energy saving control structure for water-cooled air conditioning of the present invention includes: a power module 1, a control element 11 configured thereon, and one side of the control element 11 configured with a temperature sensing element 12; a first electric circuit 2, configured on one side of the power module 1 and in selective electric connection with the power module 1, the first electric circuit 2 in electric connection with at least one air circulation device 21, including a piece of air supply equipment 211 and at least one first motor 212 configured on one side of the air supply equipment 211; and a second electric circuit 3, configured on another side of the power module 1 and in selective electric connection with the power module 1, the second electric circuit 3 in electric connection with at least one cooling device 31 and compressor 32 configured on one side of the cooling device 31, and the cooling device 31 including a fan motor 311 of a cooling water tower and at least one second motor 312 configured on one side of the fan motor 311 of the cooling water tower.

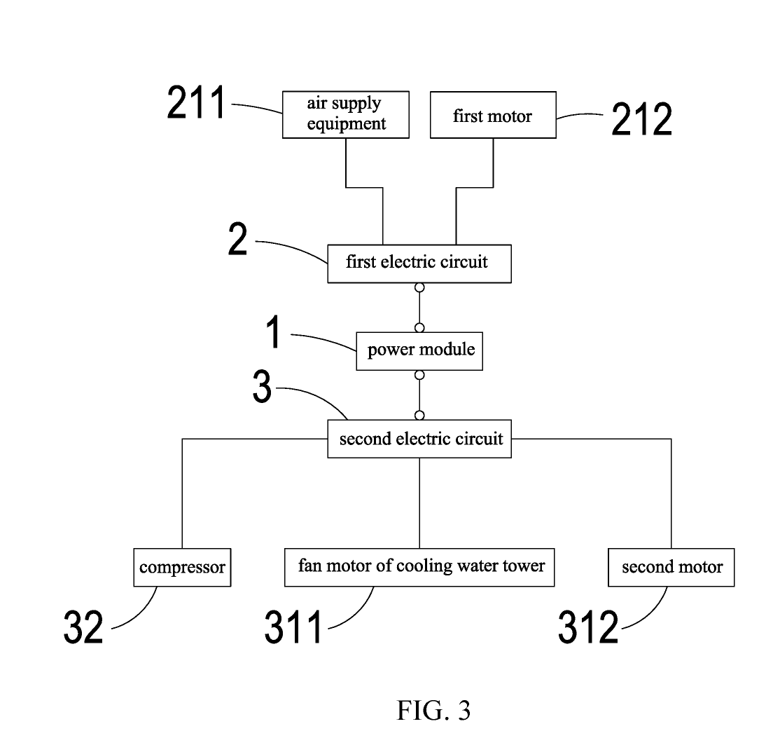

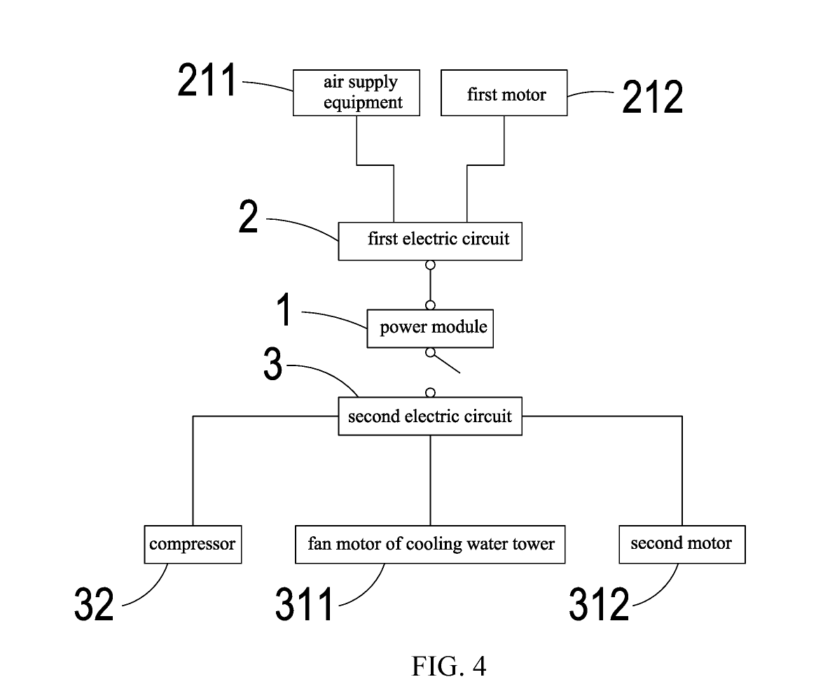

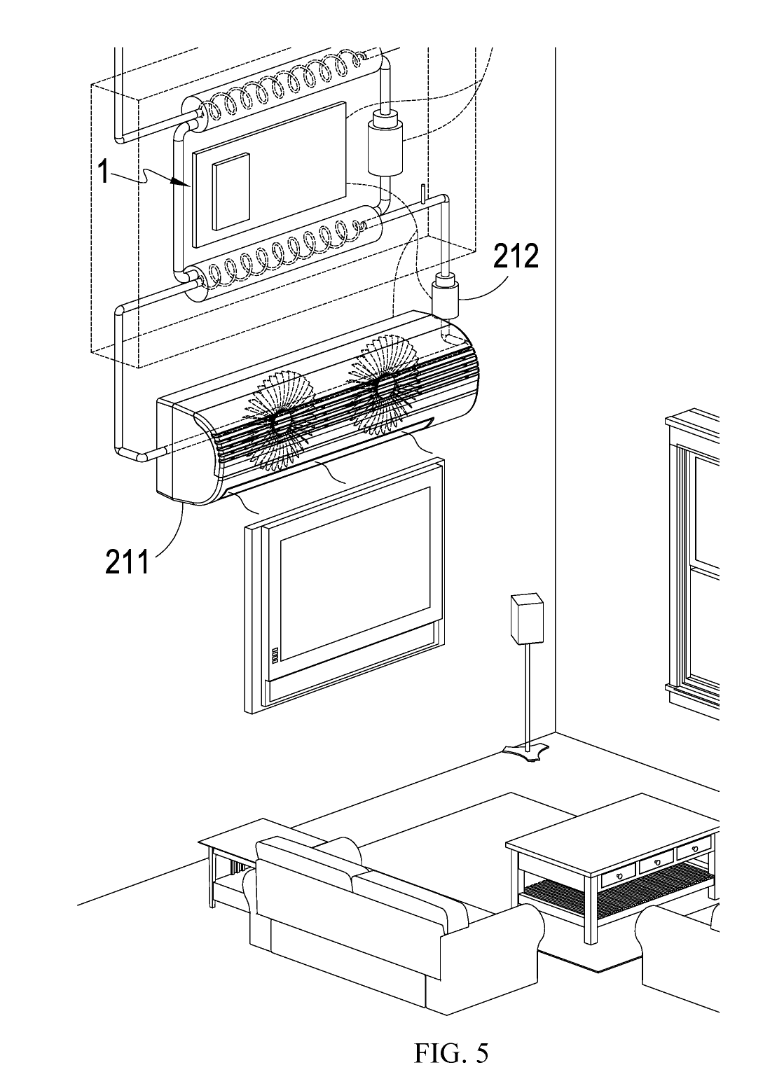

Referring to FIGS. 1 to 5, a user can set the temperature of the power module 1 through the control element 11. In addition, since the temperature sensing element 12 is configured on the indoor air supply equipment 211 or in connection with the cooling water piping of the air supply equipment 211, the indoor temperature or the temperature of the cooling water flowing into the air supply equipment 211 can be detected through the temperature sensing element 12; when the temperature detected by the temperature sensing element 12 reaches the user's set temperature, the power module 1 will cut off the power of the second electric circuit 3, allowing the compressor 32 and cooling device 31 in connection with the second electric circuit 3 to be stopped operation, and only providing power for the first electric circuit 2 to allow the air circulation device 21 to maintain indoor air circulation. Furthermore, the refrigerant temperature is decreased through the pressurization of the compressor 32 to the refrigerant and by communicating the water in the cooling water tower with the refrigerant to perform heat exchange therebetween, and the water in heat exchange with the refrigerant is allowed to be cooled by starting the fan motor 31 of the cooling water tower to drive the fan of the cooling water tower to run, allowing the water in heat exchange with the refrigerant. In addition, the water is allowed to flow continuously through the second motor 312 and in heat exchange with the refrigerant; the fan motor 311 of the cooling water tower and second motor 312 are each actuated and operated in coordination with each other, allowing the heat absorbed by the refrigerant to be carried out of the room and dissipated.

The present invention really has the following advantages in use compared to prior arts:

1. allowing the first electric circuit 2 of the indoor air circulation device 21 and the second electric circuit 3 of the cooling device 31 and compressor 32 to be separate, independent circuits; and

2. capable of closing the power of the second electric circuit 3 when indoor temperature is decreased to the user's set temperature, allowing the cooling device 31 and compressor 32 to be cut off, thereby reducing unnecessary energy consumption, and only providing indoor air circulation so as to save energy.

I claim:

1. An energy saving control structure for water-cooled air conditioning, comprising:
a power module;
a first electric circuit, configured on one side of said power module and in selective electric connection therewith, said first electric circuit in electric connection with at least one air circulation device; and
a second electric circuit, configured on another side of said power module and in selective electric connection therewith, said second electric circuit in electric connection with at least one cooling device and a compressor configured on one side of said cooling device, and said cooling device comprising a fan motor of a cooling water tower and at least one second motor configured on one side of said fan motor of said cooling water tower

2. The structure according to claim 1, wherein a control element is configured on said power module.

3. The structure according to claim 2, wherein a temperature sensing element is configured on said power module and one side of said control element.

4. The structure according to claim 1, wherein said air circulation device comprises a piece of air supply equipment and at least one first motor configured on one side of said air supply equipment.
